(19) United States
(12) Patent Application Publication
(10) Pub. No.: US 2014/0319824 A1
(43) Pub. Date: Oct. 30, 2014

(54) PIPE JOINTS

(71) Applicant: John Manning, Norton Sub-Course (GB)

(72) Inventor: John Manning, Norton Sub-Course (GB)

(73) Assignee: ACORN CAPITAL HOLDINGS LIMITED, Tortola (VG)

(21) Appl. No.: 14/008,866

(22) PCT Filed: Apr. 20, 2011
(86) PCT No.: PCT/GB11/50793

§ 371 Date: Dec. 5, 2013

(30) Foreign Application Priority Data
Mar. 29, 2011 (GB) 1105189.3

(51) Int. Cl. F16L 37/14

(52) U.S. Cl. CPC F16L 37/148
USPC 285/321

(57) ABSTRACT

A connection end for a pipe joint (2) having a wall defining a receiving recess (8) for receiving an end of a pipe length (4); a groove (12) formed to a depth in an internal surface of the wall of the receiving recess (8);a channel (34) communicating between the groove and an external surface of the connection end; the channel (34) and groove (12) being configured to receive a flexible elongate connector (30) having an axial cross-section with an aspect ratio of greater than 1, and seatable within the groove via the channel, the connector having a width greater than the depth of the groove so that when seated within the groove the connector extends into the receiving recess; and wherein the profiles of said groove and said channel are configured such that when such a connector is seated within the groove, the major axis of the axial cross-section of said connector may be aligned to be neither per pendicular nor parallel to the axis of the conduit.

### FIELD OF THE INVENTION

The present invention relates to a joint for connecting tubular conduits, in particular for connecting lengths of pipe to form a fluid transport system. The invention also relates to connection ends for such joints, and pipe connectors for use therein.

### BACKGROUND OF THE INVENTION

Fluid transport systems are known for conveying materials, such as liquids and gasses, with common examples including water and fuels such as gas and oil. The systems may include oil and gas pipelines for conveying fuel over thousands of miles. The tubular conduits used in fluid transport of fuel may be made of different metals, including steel, iron, copper, aluminium and plastic.

For small bore plastic pipes a press or screw fit joint can be used, and in copper pipe, the use of soft solder is the usual means of joint connection.

For larger diameter pipes, typically 1 to 1.5 metres (around 40 to 60 inches) in diameter, used in the transport of fuel, welded joints are commonly used. However, welded joints have the disadvantage of requiring skilled workers as well as having negative health and safety and environmental implications. For example, construction of gas or oil conveying pipelines, which are typically made from approximately 12 metre (40 feet) long lengths of steel pipe with a diameter of 1 to 1.5 metres (around 40 to 60 inches) and conventionally use welded joints. Each joint can take a skilled team a whole day to make, when taking into consideration, the deployment of equipment at the joint location and inspection of the joint by X-ray equipment. Also, around 1 in 10 of such welded joints will have to be repaired after an inspection. This makes oil and gas pipelines expensive and time consuming to construct and maintain. A further problem with press fit and welded joints is that they are difficult to disconnect, for example, for repair or maintenance, and once disconnected are not generally re-useable. Furthermore, disconnection of press fit or welded joints often results in damage to the pipe lengths.

A pipe connector employing the general principles underlying the present invention was disclosed in International Patent Application WO 2010/046627. The present invention seeks to improve the effectiveness, reliability and resilience of the known connector, especially for service at high pressures.

### SUMMARY OF THE INVENTION

Accordingly, the invention provides a connection end for a pipe joint comprising a conduit, said connection end comprising: a wall defining a receiving recess for receiving an end of a pipe length; a groove formed to a depth in an internal surface of the wall of the receiving recess; a channel communicating between the groove and an external surface of the connection end; said channel and groove being configured to receive a flexible elongate connector having an axial cross-section with an aspect ratio of greater than 1, said connector being seatable within the groove via the channel, and said connector having a width greater than the depth of the groove so that when seated within the groove the connector extends into the receiving recess; and wherein the profiles of said groove and said channel are configured such that when such a connector is seated within the groove, the major axis of the axial cross-section of said connector may be aligned to be neither perpendicular nor parallel to the axis of the conduit.

The provision of such an arrangement of non-circular connectors, and correspondingly shaped grooves increases the pressure-resistance of the pipe joint. As will be discussed herein, the arrangement is such that pressure within the conduit, and other forces that would normally act to separate the joint have the effect of increasing the joint strength by urging the connector into tighter contact with the groove in the pipe and in the pipe connection.

Preferably, said groove and said channel are configured so that when such a connector is seated within the groove, the major axis of the axial cross-section of said connector lies at an angle of between 15 and 80 degrees to the axis of the conduit, and more preferably at an angle of between 30 and 60 degrees to the axis of the conduit. In especially preferred embodiments the angle is between 40 and 50 degrees, and especially about 45 degrees.

The invention also provides a pipe joint comprising a connection end described above and an elongate connector said connector having an axial cross-section with an aspect ratio of greater than 1, said connector being seatable within the groove via the channel, and said connector having a width greater than the depth of the groove so that when seated within the groove the connector extends into the receiving recess. Preferably, the aspect ratio of the axial cross-section of the connector is at least 1.2, 1.4, 1.6, 1.8 or at least 2. Embodiments are envisaged where the aspect ratio is greater than 3 or 4. Increasing the aspect ratio in this way increases the effect of the “automatic tightening” of the joint under pressure.

Preferably, in such a pipe joint the groove has a transverse cross-section that matches a segment of a transverse cross-section of the connector.

Preferably, in such a pipe joint or connection end, the groove extends in a substantially circumferential direction along the internal surface of the wall of the receiving recess. More preferably, the groove is an annular groove.

Preferably, in such a pipe joint the connector extends substantially all the way around the groove.

This distributes loads evenly around the pipe joint.

Also in any such pipe joint, the connector has a first end insertable into the channel and a second end, remote from the first end, which second end is sealable against an external surface of the connection end. The ability to seal the connector against an external surface of the connection end prevents ingress of material into the connection joint, and can be used to secure the connection against unwanted dismantling. Preferably the second end of said connector comprises a graspable handle.

Inanysuchpipe joint or connection end, it is preferred that the channel and the groove merge smoothly. This facilitates the insertion of the connector into the groove.

In any such pipe joint or connection end, it is envisaged that the conduit comprises a valve arrangement.

Also in any such pipe joint or connection end it is preferred that there is additionally a pipe end face abutment extending inwardly of an internal surface of the conduit. Preferably, the abutment is an annular abutment and the abutment forms a seat for an annular seal.

Any such pipe joint or connection end preferably additionally comprises a sealing assembly. Such sealing assembly might comprise an O-ring, or a square-section annular seal, so sized as to seat against the pipe end face abutment.

The invention also provides a pipe assembly comprising a pipe joint or connection end described herein connected to a length of pipe, wherein the pipe is formed with a groove on its external surface corresponding to a groove in the internal surface of the wall of the connection end and the connector when seated in the groove in the wall of the end connection extends into the groove in the pipe length.

In any such connection end, pipe joint or pipe assembly, more than one such arrangement of grooves and connectors may be provided for each joint, to further increase the strength, resilience and security of the pipe joints.

The invention also provides a method of making a pipe assembly described herein, comprising the steps of: inserting an end of the pipe length into the receiving recess; aligning a groove in the pipe with a corresponding groove in the internal wall of the receiving recess; and inserting the connector, via the channel, into a space formed by the aligned grooves.

The invention also provides a pipe comprising a conduit formed with a connection end comprising a wall defining a surface to be received in a pipe joint; and a groove formed to a depth in an external surface of the wall, said groove being configured to receive a flexible elongate connector having an axial cross-section with an aspect ratio of greater than 1, said connector being seatable within the groove via the channel, and said connector having a width greater than the depth of the groove so that when seated within the groove the connector extends into the receiving recess; and wherein the profile of said groove is configured such that when such a connector is seated within the groove, the major axis of the axial cross-section of said connector may be aligned to be neither perpendicular nor parallel to the axis of the conduit. Again, the aspect ratio of the axial cross-section of the connector is preferably at least 1.2, 1.4, 1.6, 1.8 or at least 2. Embodiments are envisaged where the aspect ratio is greater than 3 or 4. Increasing the aspect ratio in this way increases the effect of the “automatic tightening” of the joint under pressure.

The invention also provides a pipe joint connector, suitable for use with a connection end or pipe joint described herein, said connector comprising a flexible elongate member having an axial cross-section with an aspect ratio of greater than 1. Again, the aspect ratio of the axial cross-section of the connector is preferably at least 1.2, 1.4, 1.6, 1.8 or at least 2. Embodiments are envisaged where the aspect ratio is greater than 3 or 4. Increasing the aspect ratio in this way increases the effect of the “automatic tightening” of the joint under pressure. The flexibility of the connection member allows it to deform to the shape of the groove when inserted.

Preferably, the pipe joint connector comprises successive layers of helically-wound wire. The inventor has found that such a construction provides excellent flexibility and strength, and allows lubricants and/or sealants to be introduced within the interstices between the wires. Preferably, each successive layer or wire is wound in an alternating direction, and more preferably successive layers of wire, from the centre to the surface of the connector, are composed of an increasing number of individual strands. This gives additional strength and flexibility.

The inventor has also found it advantageous that any such pipe joint connector has a central core of material said core having an axial cross-section with an aspect ratio of greater than 1. Again, the aspect ratio of the axial cross-section of the core is preferably at least 1.2, 1.4, 1.6, 1.8 or at least 2. This aids with construction of such a connector, and provides additional strength and resistance to buckling when the connector is introduced. More preferably still, said central core comprises a material that expands upon heating. Many fluid transport systems operate at elevated temperatures, or are subject to elevated environmental temperatures. By using such an expanding core, the elevated temperatures increase the locking action of the pipe connector, giving improved performance in the face of temperature fluctuations. Preferably, such a central core is composed of copper or aluminium.

In any such wire-formed connector, it preferably further comprises a channel in fluid communication with interstices between said wire, said channel extending to an end region of the connector, thereby enabling a lubricant or sealant to be introduced around said connector via said channel.

In accordance with one aspect of the present invention, there is provided a pipe joint comprising: a conduit formed with at least one connection end wherein each connection end comprises: a housing containing a circular recess for receiving an end of a pipe length; a shaped groove formed to a depth in the internal surface of the curved wall of the receiving recess; a channel communicating between the shaped groove and the external surface of the connection housing, and a shaped connector formed from a length of material which is slid able within the groove via the channel and which is wider than the depth of the shaped groove so that when seated within the shaped groove the connector extends into the receiving recess.

References in this specification to a “shaped groove” refer (for sake of brevity) to a groove having a shape to receive a segment of a connector having an axial cross-section with an aspect ratio of greater than 1, and configured such that when such a connector is seated within the groove, the major axis of the axial cross-section of the said connector may be aligned to be neither perpendicular nor parallel to the axis of the conduit.

A length of pipe to be connected to the pipe joint is formed with a shaped groove on its external diameter corresponding with but offset longitudinally to the shaped groove in the internal surface of the wall of the one in the housing. The connector, when seated in the shaped groove in the wall of the housing, extends into the corresponding shaped groove in the external diameter of the pipe length. In order to provide a stable fixing, which also contributes to the sealing of the pipe length within the pipe joint, the connector may fit snugly between the grooves.

A pipe length may be fitted into the pipe joint by following the steps of: Inserting an end of the pipe into the receiving recess of the housing; aligning the shaped groove in the pipe with the corresponding shaped groove in the internal wall of the receiving recess of the housing; and inserting the connector, via the channel, into a spaced formed by the aligned shaped grooves. A number of shaped grooves in the pipe may match a corresponding number of shaped grooves in the wall of the receiving recess of the housing and a connector may be provided for each set of corresponding shaped grooves. The fitting of the pipe length into the pipe joint may be carried out by sliding the length of material forming the connector along the space between the corresponding shaped grooves via the channel. The connector straddles the shaped groove in the internal surface of the wall of the receiving recess of the housing and the shaped groove in the external surface of the pipe length to fix the pipe length in the pipe joint.

The pipe joint according to the present invention is relatively cheap to make and install. It is also safe to install as it does not require welding. In addition, the fixing can be undone for repair or maintenance from the outside of the pipe joint by simply removing the connector from the grooves via the channel. An engagement means may, for example, be a graspable fitting provided at one end of the connector for this purpose. Fitting the pipe length within the pipe joint may comprise the additional steps of forming the shaped groove in the internal surface of the wall of the housing, and forming a shaped groove in the external surface diameter of the pipe length. Cutting tools are available in the art for cutting such grooves in pipes and pipe joints.

The connector may be formed from a length of flexible, and preferably resilient material which is able to take up the shape of the shaped groove in the internal surface of the wall of the receiving recess of the housing, when the connector is moved via the channel into the groove. For example, the connector may be formed from a length of metal wire formed in such a manner as that used in the manufacture of a coil spring but with multiple layers and with multiple starts, each layer to be wound in a alternating direction.

In addition, the connector may be covered with a low-friction coating, such as PTFE, commonly sold under the registered trade mark Teflon®, to aid the movement of the connector through the channel and the shaped groove.

There may be one or more shaped grooves in the receiving recess of the housing, with a corresponding channel and connector for each groove. In this case a corresponding number of shaped grooves may be formed on the external surface of the pipe end. The shaped groove in the receiving recess of the pipe length may have a transverse cross-section which matches a segment of a transverse cross-section of the connector; in particular, the segment may be a substantially oblong segment.

The shaped grooves in the receiving recess of the housing may extend in a substantially circumferential direction along the internal surface of the wall of the receiving recess of the housing. Similarly, the grooves in the pipe length may extend in a substantially circumferential direction along the external surface diameter of the pipe length. For example, the shaped grooves may be annular grooves and the connector may extend substantially all the way around the shaped groove. This arrangement provides a fixing between the connecting end and the pipe length which extends all the way around the pipe length, thus providing a high-strength connection. The shaped groove in the receiving recess of the housing may alternatively extend helically around the internal surface of the wall of the receiving recess of the housing. In this case the helical groove may extend at least once around the receiving recess.

The length of material of the connector may have a first end insertable into the channel and a second end, remote from the first end, the second end may be seatable against an external surface of the connection end, for example, when the connector is fully inserted. In order to facilitate insertion of the connector into the groove via the channel, the channel and the groove may merge smoothly.

The conduit may comprise a valve arrangement, but it may also comprise another length of pipe or any other conduit used to connect to one or more pipe lengths. Typically, the internal surface of the wall of the receiving recess may be substantially cylindrical, in order to receive a standard cylindrical pipe.

The joint may additionally comprise a pipe end face abutment extending inwardly of an internal surface of the conduit. In this case the abutment may be an annular abutment and the abutment may form a seat for an annular seal.

The annular seal may seal between the annular abutment and an end face of the pipe length.

In a further aspect, the inventor provides pipe coupler comprising a wall defining a receiving recess for receiving an end of a pipe length at each end of said coupler; a connector-receiving groove located at each end of said coupler and formed to a depth in an internal surface of the wall of the receiving recess; a channel communicating between the each connector-receiving groove and an external surface of the connection end; said channel and groove being configured to receive a flexible elongate connector seatable within the groove via the channel, and said connector having a width greater than the depth of the groove so that when seated within the groove the connector extends into the receiving recess, and wherein the bore of the coupler is unimpeded by inwardly-extending projections.

Preferably, said coupler further comprises two O-ring receiving grooves circumferentially disposed on an internal surface of the wall of the receiving recess, and located between said connector-receiving grooves.

Also included within the scope of the invention is a connection end for a pipe joint, a pipe joint, a pipe assembly, a method of making a pipe assembly, a pipe joint connector and a pipe coupler substantially as described herein with reference to and/or as illustrated by any appropriate combination of the accompanying drawings.

Further features and advantages of the invention will become apparent from the following description of preferred embodiments of the invention, given by way of example only, which is made with reference to the accompanying drawings.

### BRIEF DESCRIPTION OF THE DRAWINGS

The invention will be described with reference to the accompanying drawings in which:

FIG. 1 shows a partial longitudinal cross-section of a pipe joint incorporating a tap and a length of pipe in accordance with a first embodiment of the present invention;

FIG. 2 shows a partial transverse cross-section through line A-A of FIG. 1;

FIG. 3 shows a partial longitudinal cross-section of a flanged pipe joint in accordance with a second embodiment of the present invention;

FIG. 4 shows a partial transverse cross-section through line B-B of FIG. 3;

FIG. 5 shows a partial longitudinal cross-section of a pipe joint in accordance with a third embodiment of the present invention;

FIG. 6 shows a side view of the pipe joint of FIG. 5;

FIG. 7 shows a partial transverse cross-section of the pipe joint of FIG. 5;

FIG. 8 shows a partial longitudinal cross-section of a pipe joint in accordance with a fourth embodiment of the present invention; FIG. 9 shows an enlarged longitudinal cross-sectional view of the pipe joint and the acting internal pressers.

FIG. 10 shows an enlarged longitudinal cross-sectional view of the pipe joint and the acting forces. FIG. 11 shows a transverse cross-section through the connection ring 30

FIG. 12 shows a transverse cross-section through an alternant connection ring 30

FIG. 13 shows a transverse cross-section through a further alternate connection ring 30

FIGS. 14-16 illustrate cross-sections of a pipe connector

FIGS. 17 to 27 illustrate the configuration of “shaped grooves” of the present invention.

### DESCRIPTION OF PREFERRED EMBODIMENTS

Like parts are represented by like numerals in each of the Figures.

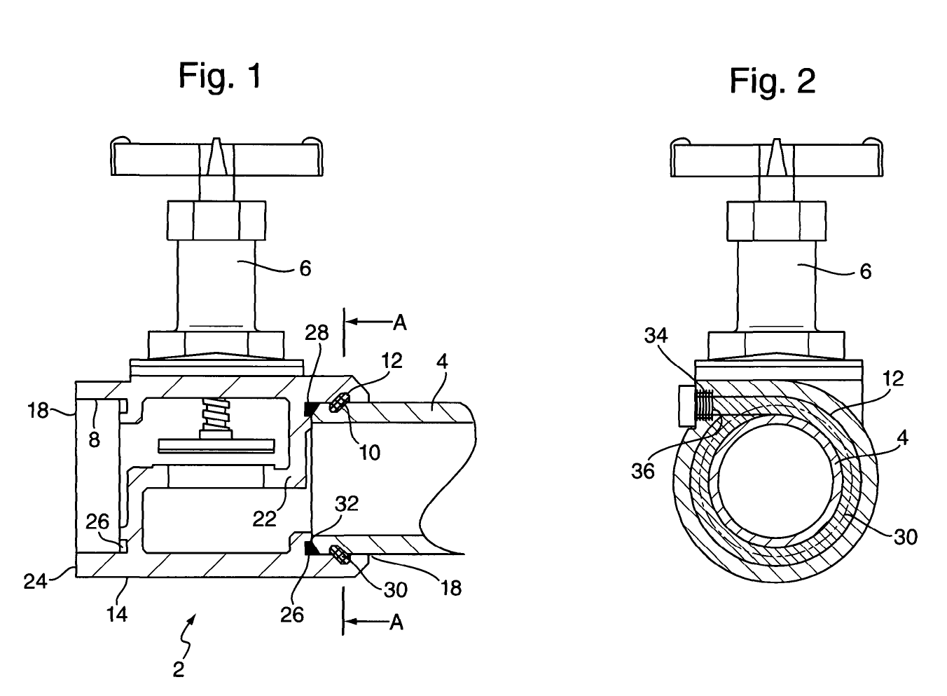

FIG. 1 shows a partial longitudinal cross-section through a pipe joint 2 connected to a length of pipe 4. Only the end of the pipe length 4 connected to the pipe joint 2 is shown in FIG. 1. The pipe joint 2 comprises a conduit 14 with two open connection ends 18. The conduit 14 incorporates a valve arrangement 6, as is known in the art; however, the conduit 14 need not incorporate a valve arrangement, but may comprise any length or shape of conduit with one or more such open connection ends 18. Each connection end 18 is formed with a receiving recess 8 shaped to receive an end of a pipe length 4; the receiving recess 8 generally has a substantially circular transverse cross-section. The receiving recess 8 is formed with an end face 24. A substantially circumferential annular shaped groove 12 is formed in the internal surface of the wall of the receiving recess 8. The shaped groove 12 is described in more detail below.

The shaped groove 12 may be formed when the pipe joint 2 is formed; alternatively, the groove 12 can be cut into the internal surface of the receiving recess 8 using a cutting tool of the type known in the art for cutting such shaped grooves. The shaped groove 12 communicates with an external surface of the wall of the receiving recess 8 via a channel 34, as shown in FIG. 2. The channel 34 merges smoothly into the groove 12, extending substantially tangentially from the bed of the shaped groove 12. Each receiving recess 8 is terminated at its end remote from the end face 24 by a collar 22, which collar 22 extends radially inwardly from the internal surface of the conduit 14. In FIG. 1, each collar 22 also forms part of the chambers of the valve arrangement 6. The collar 22 is formed with an annular abutment 16 extending from the collar 22 in a direction towards the end face 24, so as to form an annular seal recess 26 in a face of the collar facing towards the end face. The annular seal recess 26 is formed in the face of the collar 22 between the annular abutment 16 and the internal surface of the wall of the receiving recess 8. A resilient annular seal 28 is seated within the seal recess 26.

The pipe length 4 has formed at its end, and is connected to the pipe joint 2 by, a substantially circumferential annular shaped groove 10 on its external surface, which annular shaped groove 10 has a cross-section shaped as described below. The groove 10 may be formed when the pipe is formed; alternatively, the shaped groove can be cut into the end of the pipe length 4 using a cutting tool of the type known in the art for cutting such shaped grooves.

The annular shaped groove 12 formed in the receiving recess 8 and the annular shaped groove 10 formed in the pipe length 4 match each other, having substantially identical cross-sections.

Also, the annular shaped groove 10 formed in the pipe length 4 may be formed at a predetermined distance from an end face 32 of the pipe length 4, so that when the end face 32 abuts the annular abutment 16 of the receiving recess 8, the annular shaped grooves 10, 12 are aligned. When the grooves 10, 12 are aligned, they form an annular space of a predetermined cross-section.

Referring now to FIGS. 1 and 2, a connector with a predetermined cross-section that matches the annular space and referred to herein as a connection ring or “pipe joint connector” is fitted in the annular space formed by the aligned shaped grooves 10, 12 so as to fix the pipe length 4 within the connection end 18 of the pipe joint 2.

The connection ring 30 is formed from a length of material, for example a length of wound metal wire (which may be multi-stranded and multi layered) of spring steel, which material has a cross-section that matches the annular shaped space. One end of the length of material may be formed into a graspable shape, for example, in the form of a thread 36. With the graspable end 36 abutting the external surface of the wall of the receiving recess 8, adjacent the channel 34, the length of the connection ring is long enough to substantially fill the annular space formed by the annular grooves 10, 12, i.e. long enough to extend completely around the shaped groove 10 in the pipe end 4. The cross-section of the connection ring 30 is matched to the cross-section of the space formed by the aligned shaped grooves 10, 12, so that the connection ring 30 fits snugly between the aligned grooves. The connection ring 30 performs the function of locking the pipe end 4 within the receiving recess 8 of the pipe joint 2. This is achieved by providing a tight fit, or even an interference fit, which inhibits separation of the pipe joint 2 when the connection ring 30 is located within the annular space formed by the aligned annular grooves 10, and 12.

The connection between the pipe joint 2 and the end of the pipe length 4 is formed as follows. The end of the pipe length 4 is slideably located within the receiving recess 8 of the pipe joint 2 until the end face 32 of the pipe length 4 abuts the abutment 16. This traps the annular seal 28 between the end face 32 of the pipe length 4 and the collar 22 of the conduit 14. The annular seal 28 forms a fluid-tight seal between the pipe length 4 and the conduit 14 of the pipe joint 2. With the end face 32 of the pipe length 4 abutting the abutment 16, the grooves 10, 12 are aligned.

An end 38 of the length of material forming the connection ring 30, which end 38 is remote from the graspable handle 36, is inserted via the channel 34 into the space formed by the grooves 10, and 12. The length of material forming the connection ring 30 is pushed around the annular space formed by the grooves 10, and 12 until the graspable end 36 abuts the external surface of the wall of the receiving recess 8 and the connection ring 30 surrounds the pipe end 4. The connection ring 30 can be pushed into the annular space manually or by means of machinery, for example a hydraulic system.

The length of material forming the connection ring 30 is flexible and preferably resilient so that it is capable of taking the shape of the annular space formed between the grooves 10, and 12 as it is inserted into the channel 34 and pushed around the annular space. The length of material forming the connection ring 30 may also be covered by a lubricating coating, such as a coating made from PTFE for example as sold under the registered trade mark Teflon®. Alternatively or in addition, the connection ring 30 may be lubricated with oil or any other suitable lubricant before it is inserted into the annular space formed between the grooves 10, and 12.

It will be appreciated that the correct lubricant can also serve a sealing material. In certain applications the conduit or pipe may not be used as part of a fluid transport system; for example, the conduit could be used as an electrical conduit for housing electrical wires. Alternatively, the conduit may be used in the construction industry and may be installed as a structure such as a barrier, handrail, mast or the like. The conduit may be used as a support, for example, as scaffolding, a support beam, rafter or the like. In these applications the joint may not require a seal 28.

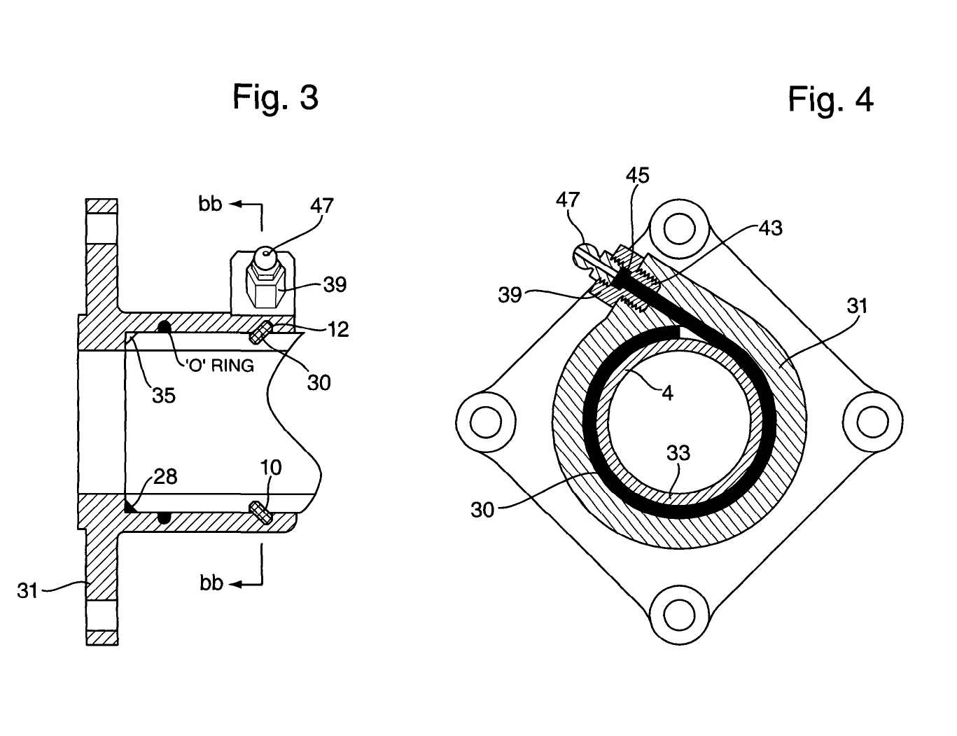

Referring now to FIG. 3 there is shown an alternative embodiment of the present invention. The pipe joint 31 is in the form of a flange connector that can be used to join a pipe length 33 to another device (not shown) such as a valve, a T-joint or another flange connector. The end face 35 of the pipe length 33 is provided with a chamfer which can be inserted into a receiving recess 37 of the pipe joint 31 and urged against an annular seal 28. As shown in FIG. 3, the annular seal 28 is not located in a recess but deforms against the chamfered end face 35 to take up a substantially triangular cross-section, and form a fluid-tight seal between the end face 35 of the pipe length 33 and the pipe joint 31. Owing to the three sealing surfaces provided by the deformed annular seal 28, the annular seal 28 is able to withstand higher pressures than that of a standard “O” ring seal.

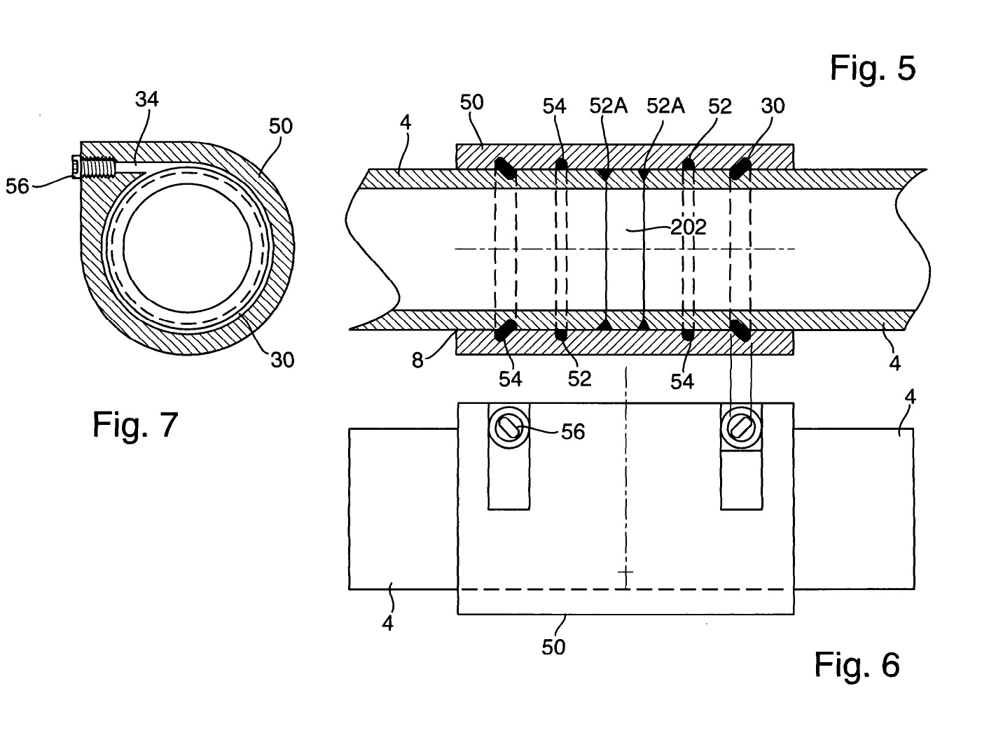

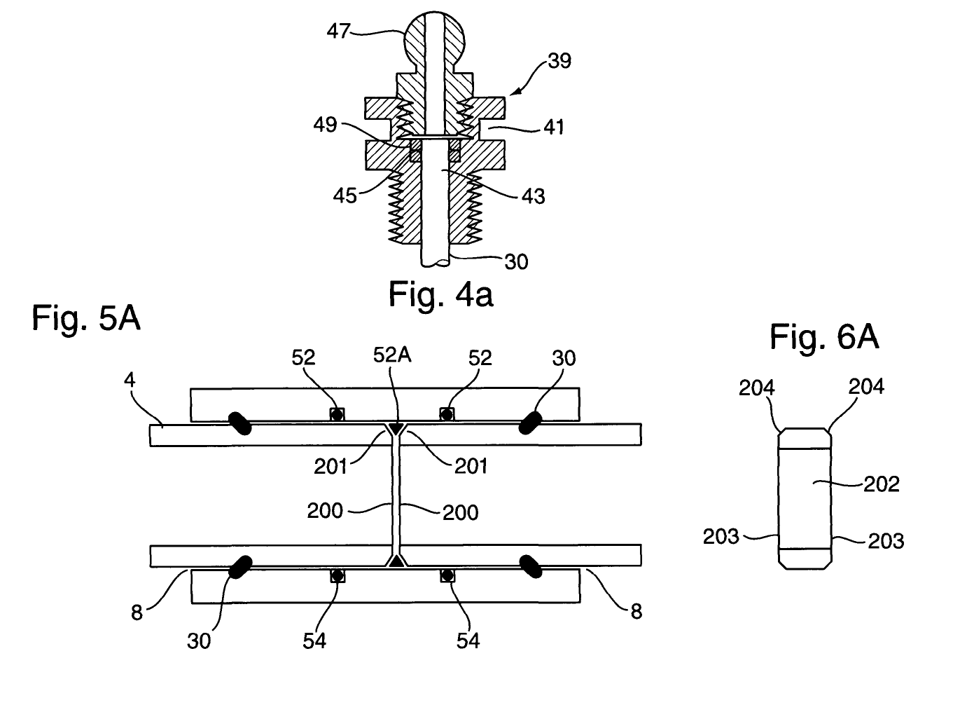

As shown in FIG. 3 and FIG. 4, the connection ring 30 does not have a handle 36 at its end. Instead, the connection ring 30 has a retainer 39 attached to the connection ring 30 for enabling insertion of the connection ring 30 into the annular space provided by the grooves 10, and 12 and for allowing extraction of the connection ring 30 from the annular space, when required.

The retainer 39 can be screwed to a corresponding threaded portion on the pipe joint 31. When the connection ring 30 is required to be removed from the annular space between the grooves 10, and 12 the retainer 39 can be rotated to unscrew it from the pipe joint 31; this rotation acts to initially free or ‘waken-up’ the connection ring 30, which can be particularly advantageous if the connection ring 30 has been located in the annular space for a long period of time.

Shown in FIG. 4a the retainer 39 is provided with a groove 41 on its periphery; this groove 41 allows a tool (not shown) to engage the retainer 39 to facilitate extraction of the connection ring 30 from the annular space between the grooves 10, and 12.

The connection ring 30 is also provided with a ferrule 45 attached to an end 43 thereof to prevent movement of the connection ring further into the annular space between the grooves 10, and 12 once it has been inserted therein. The ferrule 45 may be attached to the connection ring 30 by swaging, for example. The ferrule 45 is seated in a recess 49 in the retainer 39 and held therein by a nipple 47; the size of the recess 49 and the arrangement of the nipple 47 are such that the ferrule 45 can freely rotate within the retainer 39. The difference in size between the recess 49 and the ferrule 45 provides a channel there between through which a lubricant or sealant, which can be inserted through the nipple 47, can pass to reach the annular space in which the connection ring 30 is located.

The ferrule 45 can be shaped to have a number of flat sides around which a tool (not shown) can be placed to indirectly engage the connection ring 30 and thereby assist with insertion and/or removal of the connection ring 30 into/from the annular space formed by the grooves 10, and 12. If the ferrule 45 is provided with six flat sides, so that it has a hexagonal cross-section, for example as shown in FIG. 3, the recess in the retainer 39 should be arranged to be large enough to allow the hexagonal ferrule 45 to rotate in the recess. The recess need not be the same shape as the ferrule 45; for example the ferrule 45 may be a hexagon and the recess 49 circular.

Referring now to FIG. 5 and FIG. 5A, there is shown an alternative embodiment of the present invention. FIG. 5 shows, in longitudinal cross-sectional view, a pipe joint in the form of a simple coupler 50 which can be used for joining two lengths of pipe together. The coupler 50 comprises a hollow conduit provided with two annular seals in the form of O-rings 52 located in annular grooves 54 formed in the internal surface of the walls of a receiving recess 8. A pipe end 4, having an external “shaped groove” (as described below) may be inserted into one end of the coupler where it external surface seals against an O-ring 52 located in an annular groove 54. A connection ring 30, of the type described herein, is inserted into the pipe coupler through a channel 34 (see FIG. 7) and around the inside of the coupler, seating within the shaped grooves in both the coupler and the pipe. A second pipe end 4 is inserted in the other end of the coupler, and engages in a similar fashion. The ends of the pipes 200 located within the coupler are provided with a chamfer 201. A further O-ring 52A is located between the pipes. The dimensions of the coupler and location of the shaped groove on the pipes and coupler are so arranged that the two pipe ends abut each other within the coupler, so deforming the O-ring 52A into a substantially triangular configuration. This provides effectively a 3-point seal between the O-ring and the connection parts. The connection ring 30 ensures secure location of the pipes in the coupler. By configuring the coupler and pipe ends in this way, no further inwardly-projecting pipe end face abutment is required within the bore of the coupler, and the coupler can therefore have a substantially unimpeded bore, so reducing manufacturing costs and increasing reliability by reducing stress-focussing sites within its construction.

Optionally provided as part of the coupler is a spacer ring, or collar, 202 comprising a pipe-like conduit with an outer diameter to enable it to be slid within the bore of the coupler 50. Each end 203 of the spacer is provided with a chamfer 204. The spacer allows the distance between the pipe ends to be varied. FIG. 5 illustrates a coupler assembled using such a spacer. Additional O-rings 52A are used so that there is an O-ring seal between the end of each pipe end 4, and each end 203 of the spacer 202. The length of the spacer is chosen such that it can slide within the coupler without being able to twist and therefore snag within the bore of the coupler.

In other embodiments of the coupler 50, the connection ring 30 may be of circular cross-section, and the receiving grooves on the interior surface of the connector 50 and exterior surface of the pipe ends 4 may be so shaped as to receive such ac connection ring when aligned. Again, by configuring the coupler and pipe ends in this way, no further inwardly-projecting pipe end face abutment is required within the bore of the coupler, and the coupler can therefore have a substantially unimpeded bore, so reducing manufacturing costs and increasing reliability by reducing stress-focussing sites within its construction.

Referring also to FIGS. 6 and 7, showing a transverse cross-section of the coupler of FIGS. 5 and 5a, shows that the connection ring 30 in this embodiment does not necessarily include a graspable end 36. Instead the channel 34 is provided with a bore having a threaded portion for receiving a plug 56 which may be used to prevent ingress of any unwanted matter, for example, rain water, soil, dew or the like, from entering the channel 34. The connection ring 30 may be integral with the plug 56.

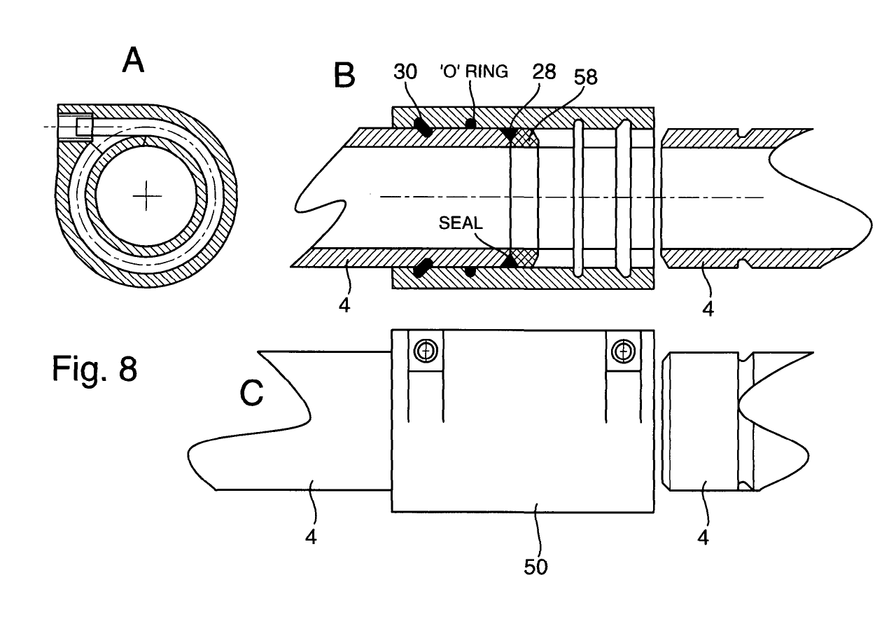

Referring now to FIG. 8 (A-C, in end, section and elevation views respectively), in an alternative embodiment the coupler 50 may be arranged to include a centre collar 58 in this embodiment the collar is able to self centre is a further embodiment the collar may be part of the housing 50 in each case a sealing ring 28 can be located to form a seal between the collar 58 and the pipe 4.

Referring now to FIG. 9 there is shown an enlarged longitudinal cross-sectional view of an embodiment of the present invention it can be seen that the connection ring 30 is located in the annular space provided between the shaped grooves 10, and 12. Owing to the offset between the housing 50 and the pipe 4 the shaped grooves 10, and 12 form an annular space that is set at an angle of in this case 45 degrees to the centre line of the conduit, this angle can vary from 15 to 80 degrees to the centre line.

As can be seen in FIG. 9 as pressure is increased in the pipe 4 the diameter of the pipe 4 is increased applying more contact with the “O” Ring Seal and more importantly applying rotational moments to the connection ring 30 in the direction of bb, this rotational movement works as a lever and transfers the force along the pipe 4 driving the pipe 4 in the direction of (CC) crushing the seal 28 and closing the gap (dd).

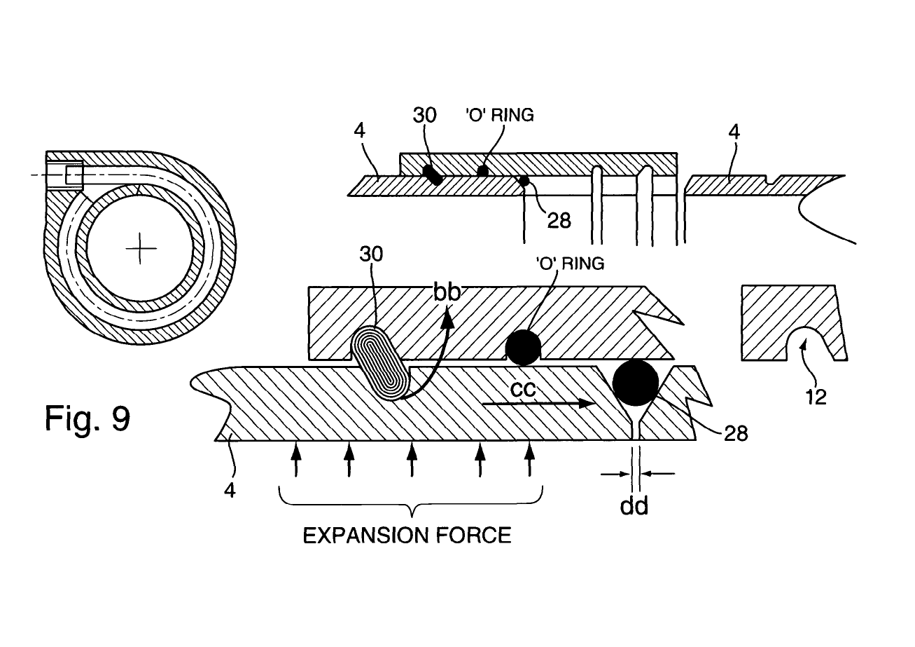

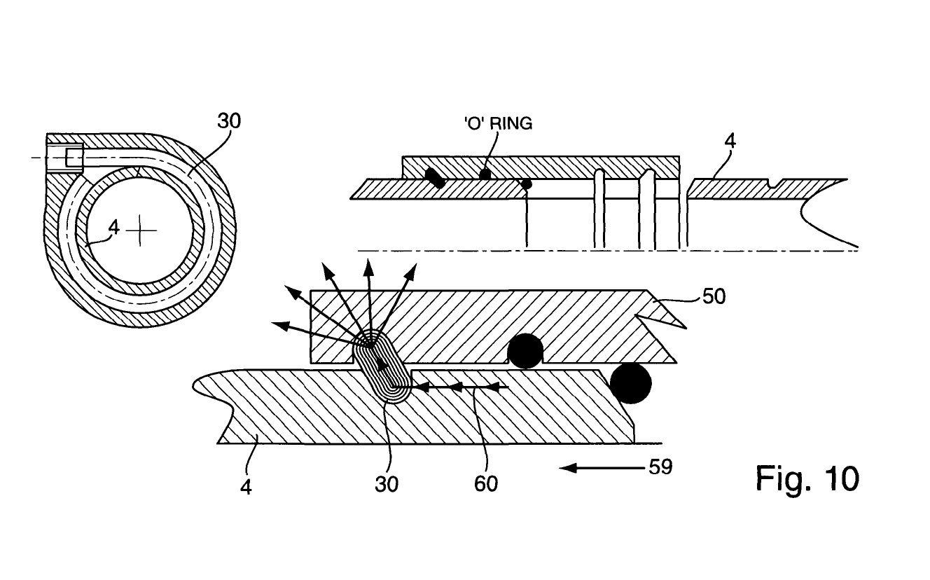

FIG. 10 also shows an enlarged longitudinal cross-sectional view of an embodiment of the present invention. It can be seen that the connection ring 30 is located at a angle in the annular space provided between the shaped grooves 10, and 12. It also shows that if an attempt were made to withdraw the pipe 4 from the housing 50 in the direction of the arrow 59, this would generate a crushing force on the connection ring 30 shown by the arrows 60. Owing to the angle of the connection ring 30 this crushing force on the connection ring 30 would be deflected through the body of the connection ring 30 and dissipated into the body mass of the housing 50 and not as in existing grooved joints that rely on the shearing action within the retaining ring and the end of the pipe fitting.

FIG. 11 illustrates a preferred embodiment of a connector 30 in a partial cross-section (FIG. 11A) and an axial cross-section view (FIG. 11B). In this embodiment, the connector 30 comprises successive layers of helically-wound wire. At the centre of the connector is a single wire 100 extending generally axially along the connector. The second layer 101 comprises a single wire, helically-wound around the inner wire 100. The third layer 102 comprises two strands of helically-wound wire, wound at an angle, as indicated, and in a different direction to the previous layer 2. Layer 4 103 comprises a helical winding of three strands of wire, again wound in an opposite direction to the previous layer. Successive layers 104, 105 and 106 have increasing numbers of wire stands (preferably increasing by an additional one wire in each successive layer). FIG. 11 shows a partial cut-way view to illustrate the successive layers of wire for clarity. Each layer of wire would, of course, extend substantially along the full length of the connector 30. The use of such multi-layered windings lead to the ability of the connection ring to flex more easily, allowing it to be manipulated into the shaped groove of the connection system.

At one end of the connector 30 is an end cap 107 connected to the wire bundle by e.g. means of a crimp 108. The end cap 107 is drilled longitudinally to form a channel 109 in fluid communication with the interstices between the strands of wire forming the connector. In this way, lubricating or sealing material may be introduced into the connector, surrounding the wires, thereby assisting insertion or removal of the connector 30 from the groove in a pipe joint. In this embodiment, the channel 109 also comprises an internal thread, to allow the interface of the connector to be sealed with a like threaded plug after insertion.

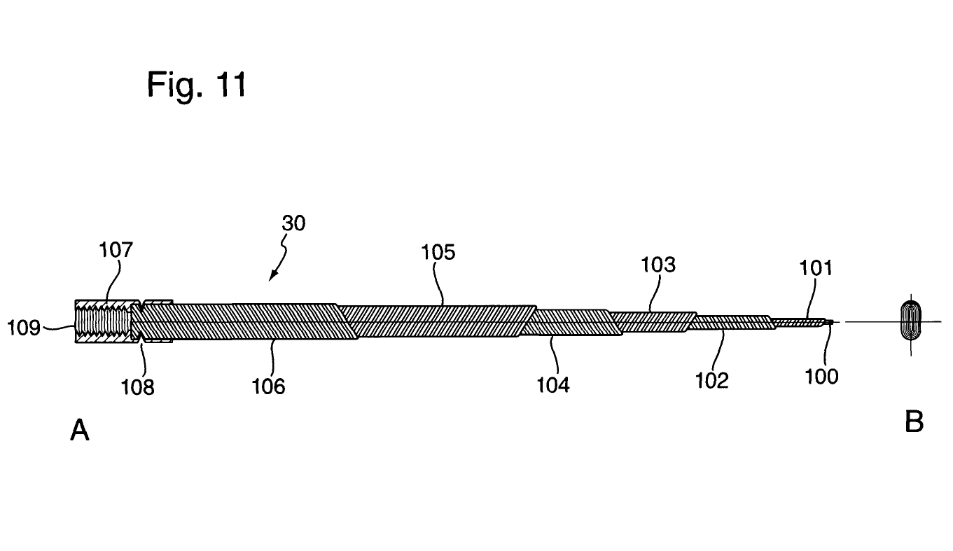

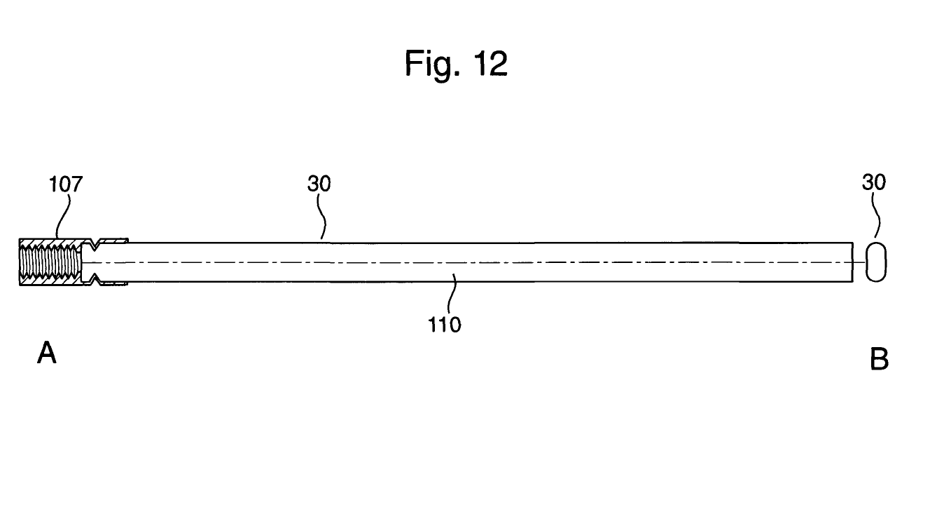

FIG. 12 illustrates an alternative embodiment of a connector 30 in a longitudinal cross-section (FIG. 12A) and an axial cross-section (FIG. 12B). In this embodiment, the connector 30 comprises a polymeric rod 110 comprised of a material such as nylon or PTFE, and having an axial cross-section aspect ratio of greater than 1, as illustrated in FIG. 12B. This embodiment also has an end cap 107, drilled and tapped to allow the insertion of a tool to assist with the insertion and removal of the connector 30 into the groove of a pipe joint.

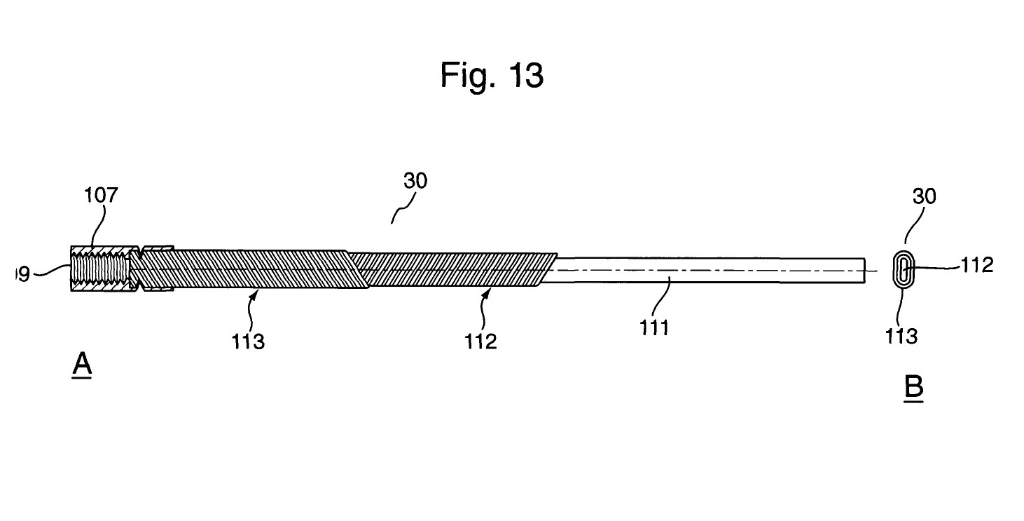

FIG. 13 illustrates a further embodiment of a connector 30 according to the present invention, again shown in partial cut-away view (FIG. 13A) and axial cross-section view (FIG. 13B). In this embodiment, the connector 30 comprises an inner core 111 of a flexible material, such as copper or aluminium. Around this core 111 is wound steel wire. In this embodiment, there is a first layer 112 comprising five strands of steel wire, wound in a helical fashion around the inner core 111. Overlaying this, is a second layer of steel wire 113 comprising six strands of steel wire, wound helically over the underneath layer, and in a different direction as indicated. Successive layers of wire maybe added, and the number of strands in each layer varied, as required, to achieve the required flexibility and strength of the connector. It can be seen from the cross-section view in FIG. 13B that the connector again has an aspect ratio greater than 1, as described herein.

At the end of the connector 30 is an end cap 107. The end cap comprises a channel 109 in fluid communication with the interstices between the strands of wire forming the layers 112 and 113. Again, the channel 109 has an internal thread to allow the end cap to be sealed with a plug when fitted, and also to allow the attachment of a handle or other means to aid insertion or removal of the connector from the pipe joint.

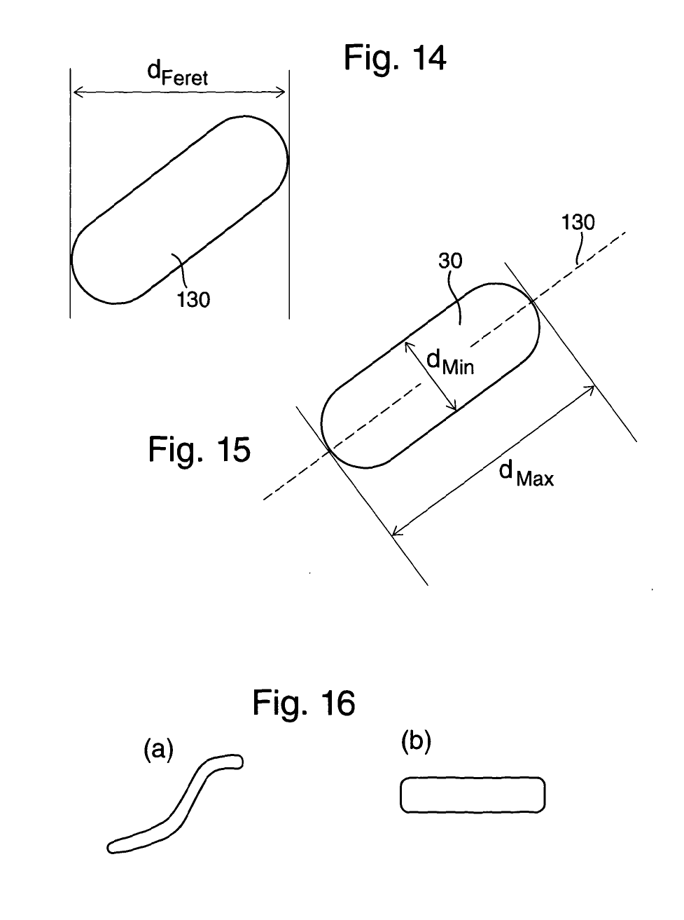

A key element of the present invention is the use of a flexible elongate connector to secure the joint between a pipe and a pipe fitting. FIG. 14-15 assist in describing an especially-preferred shape of the axial cross-section of such connectors. A commonly used measure for characterising irregularly shaped objects is the Feret diameter, which is illustrated schematically in FIG. 14. The Feret diameter is the distance between two tangents parallel to opposite sides of an object to be characterised. FIG. 14 illustrates an axial cross-section through an embodiment of a connector of the present invention 30 showing a Feret diameter.

For asymmetric non-regular shapes, the Feret diameter varies depending on the angle at which it is measured. FIG. 15 illustrates, for the shape of connector 30 shown, the minimum and maximum Feret diameters d_{Min} and d_{Max}. The aspect ratio of such a shape is defined as the ratio between the maximum and minimum Feret diameters, i.e. d_{Max}/d_{Min}. The major axis of the cross-section, i.e. that axis parallel to the longest Feret diameter, is also illustrated as 130.

FIG. 16 A-B illustrates the cross-sectional shapes of two other connectors that have the same property of an aspect ratio greater than 1.

Another important feature of the present invention is the shaped groove in an internal surface of a pipe-receiving recess, and the corresponding shaped groove on the outside surface of e.g. a pipe to be connected thereto.

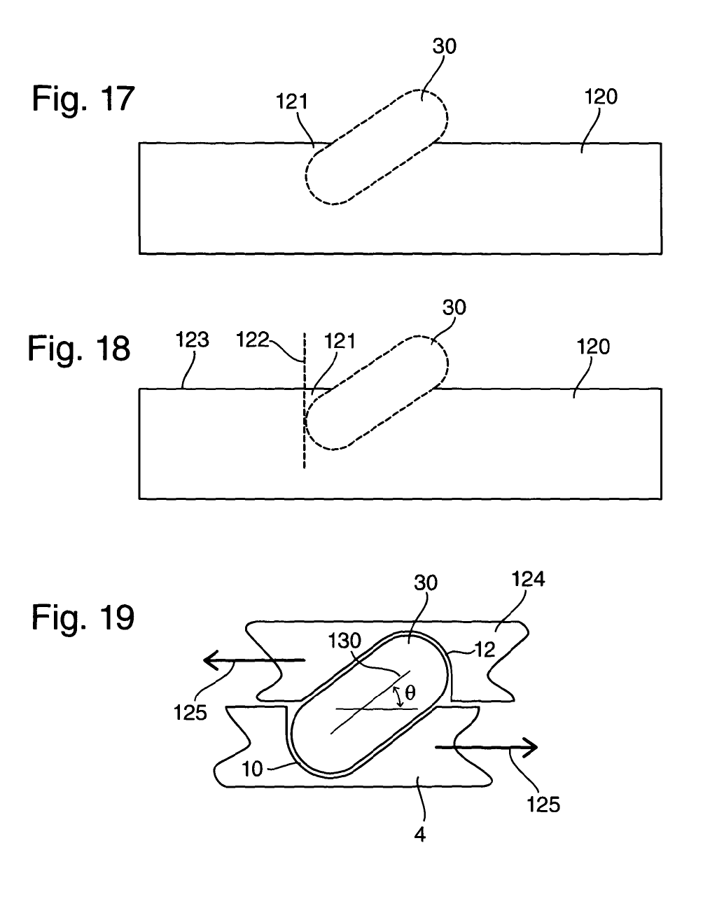

FIG. 17 illustrates schematically how the shape of such groove may be determined. FIG. 17 illustrates a cross-section through e.g. the wall of a pipe or the internal surface of a pipe fitting, the wall being illustrated by the box 120. Overlaid on this box is the cross-sectional area of a connector 30 to be employed. In order to determine the shape of the groove, a volume of revolution corresponding to a segment of the cross-sectional area of the connector 3 is removed from the surface of the pipe or connector, illustrated by the dotted outline of the connector 30 in FIG. 17.

Whilst such a groove maybe employed, the overhang 121 created by undercutting the groove to match the angled connector channel leaves a sharp edge, with risk of injury to operators. FIG. 18 illustrates that this edge maybe removed, for example along the dotted line 122, normal to the surface 123 of the block 120. This shape is illustrated in further figures.

FIG. 19 illustrates a connector 30 of the present invention in position within two aligned grooves 10, 12 formed respectively in the walls of a pipe 4 and the internal surface of a connection end 124 as part of a pipe joint. It can be seen that the major axis 130 of the axial cross-section of the connector 30 is orientated at an angle θ (theta) from the longitudinal axis of the pipe conduit. The orientation is such that forces that would tend to separate the pipe joint, illustrated by the arrows 125 act to urge the connector 30 further within the grooves formed in the surface of the pipe and pipe connector and leading, in the orientation of FIG. 19 to a rotational movement of the connector 30 about its longitudinal axis in an anticlockwise direction.

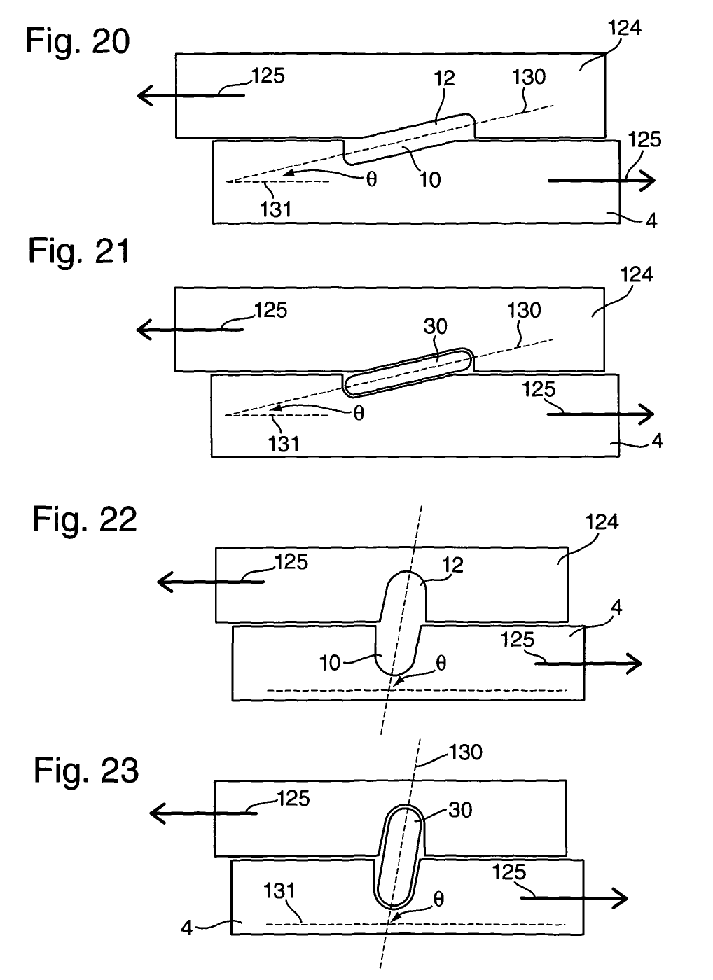

FIG. 20 illustrates the arrangement of two grooves 10 and 12 (shown in cross-section) respectively in the surface of a pipe 4 and internal surface of a pipe fitting 124. The shape of the grooves is formed as described above and it can be seen that the major axis 130 of the aligned grooves is offset at an angle 0 (theta) from the longitudinal axis 131 of the pipe 4, or conduit. In this example, the angle is 15 degrees.

FIG. 21 illustrates the arrangement of FIG. 20 with a pipe connector 30 in place within the aligned grooves 10 and 12. It can be seen in both FIGS. 20 and 21 that the angle of the combined grooves 10 and 12 and therefore of the connector 30 when in place is such that forces, represented by the arrows 125, that would otherwise tend to decouple the pipe joint have the affect of urging the connector 30 further into the groove, thereby increasing the strength of the joint.

FIGS. 22 and 23 correspond to FIGS. 20 and 21, but illustrating an arrangement where the major axis 130 of the aligned grooves, and therefore of the connector 30, is at 80 degrees to the longitudinal axis 131 of the pipe 4.

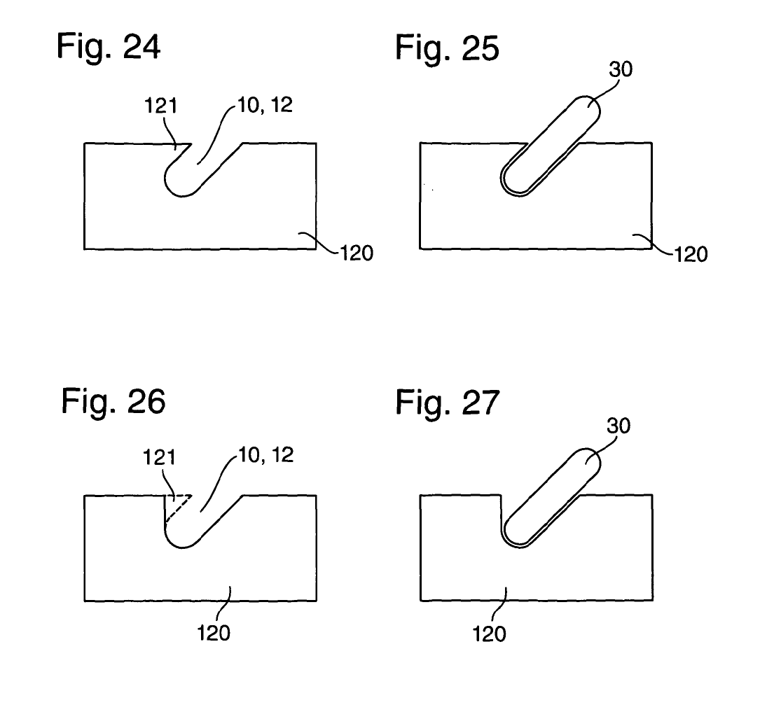

FIG. 24 is a further illustration of the cross-section of a groove 10 and 12 formed either in the outer surface of a pipe 4 or the internal surface of a pipe connection, again represented by a box 120. In FIG. 24, the shape of the groove is such as to match a portion of a pipe connector 30, illustrated in FIG. 25, in position within the groove. The pipe connector 30 fits snugly within the groove so as to almost completely fill it. As discussed above, this arrangement provides good seating but leaves a potential injurious sharp edge on the overhanging portion 121 and the edge of the groove.

FIGS. 26-27 illustrate, therefore, an alternative groove profile in which the overhanging portion 121 has been removed, to remove the sharp edge. The remaining groove 10, 11 still allows the connector 30, illustrated in FIG. 27 to be aligned at the required angle, as illustrated in FIG. 27.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A connection end for a pipe joint comprising a conduit, said connection end comprising:
a wall defining a receiving recess for receiving an end of a pipe length;
a groove formed to a depth in an internal surface of the wall of the receiving recess;
a channel communicating between the groove and an external surface of the connection end;
said channel and groove being configured to receive a flexible elongate connector having an axial cross-section with an aspect ratio of greater than 1, said connector being seatable within the groove via the channel, and said connector having a width greater than the depth of the groove so that when seated within the groove the connector extends into the receiving recess;
and wherein
the profiles of said groove and said channel are configured such that when such a connector is seated within the groove, the major axis of the axial cross-section of said connector may be aligned to be neither perpendicular nor parallel to the axis of the conduit.

2. A connection end according to claim 1 in which said groove and said channel are configured so that when such a connector is seated within the groove, the major axis of the axial cross-section of said connector lies at an angle of between 15 and 80 degrees to the axis of the conduit.

3. A connection end according to claim 2 in which said groove and said channel are configured such that when such a connector is seated within the groove, the major axis of the axial cross-section of said connector lies at an angle of between 30 and 60 degrees to the axis of the conduit.

4. A pipe joint comprising a connection end according to any preceding claim and an elongate connector said connector having an axial cross-section with an aspect ratio of greater than 1, said connector being seatable within the groove via the channel, and said connector having a width greater than the depth of the groove so that when seated within the groove the connector extends into the receiving recess.

5. A pipe joint according to claim 4 in which the groove has a transverse cross-section that matches a segment of a transverse cross-section of the connector.

6. A pipe joint or connection end according to any one of the preceding claims, wherein the groove extends in a substantially circumferential direction along the internal surface of the wall of the receiving recess.

7. A pipe joint or connection end according to any one of the preceding claims, wherein the groove is an annular groove.

8. A pipe joint according to any preceding claim dependent on claim 4, wherein the connector extends substantially all the way around the groove.

9. A pipe joint according to any preceding claim dependent on claim 4, wherein the connector has a first end insertable into the channel and a second end, remote from the first end, which second end is sealable against an external surface of the connection end.

10. A pipe joint according to claim 9, wherein the second end of said connector comprises a graspable handle.

11. A pipe joint or connection end according to any one of the preceding claims, wherein the channel and the groove merge smoothly.

12. A pipe joint or connection end according to any one of the preceding claims, wherein the conduit comprises a valve arrangement.

13. A pipe joint or connection end according to any one of the preceding claims additionally comprising a pipe end face abutment extending inwardly of an internal surface of the conduit.

14. A pipe joint or connection end according to claim 13, wherein the abutment is an annular abutment and the abutment forms a seat for an annular seal.

15. A pipe joint or connection end according to any one of the preceding claims additionally comprising a sealing assembly.

16. A pipe assembly comprising a pipe joint or connection end according to any one of the preceding claims connected to a length of pipe, wherein the pipe is formed with a groove on its external surface corresponding to a groove in the internal surface of the wall of the connection end and the connector when seated in the groove in the wall of the end connection extends into the groove in the pipe length.

17. A method of making a pipe assembly according to claim 16, comprising the steps of:
inserting an end of the pipe length into the receiving recess; aligning a groove in the pipe with a corresponding groove in the internal wall of the receiving recess; and inserting the connector, via the channel, into a space formed by the aligned grooves.

18. A pipe comprising:
a conduit formed with a connection end comprising a wall defining a surface to be received in a pipe joint;
and a groove formed to a depth in an external surface of the wall, said groove being configured to receive a flexible elongate connector having an axial cross-section with an aspect ratio of greater than 1, said connector being seatable within the groove via the channel, and said connector having a width greater than the depth of the groove so that when seated within the groove the connector extends into the receiving recess;
and wherein the profile of said groove is configured such that when such a connector is seated within the groove, the major axis of the axial cross-section of said connector may be aligned to be neither perpendicular nor parallel to the axis of the conduit.

19. A pipe joint connector, suitable for use with a connection end or pipe joint according to any of claims 1 to 15, said connector comprising a flexible elongate member having an axial cross-section with an aspect ratio of greater than 1.

20. A pipe joint connector according to claim 19 comprising successive layers of helically-wound wire.

21. A pipe joint connector according to claim 20 wherein each successive layer or wire is wound in an alternating direction.

22. A pipe joint connector according to either claim 20 or claim 21 wherein successive layers of wire, from the centre to the surface of the connector, are composed of an increasing number of individual strands.

23. A pipe joint connector according to any of claims 20 to 23 having a central core of material said core having an axial cross-section with an aspect ratio of greater than 1.

24. A pipe joint connector according to claim 23 wherein said central core comprises a material that expands upon heating.

25. A pipe joint connector according to claim 24 wherein said central core is composed of copper or aluminium.

26. A pipe joint connector according to any of claims 20 to 25 further comprising a channel in fluid communication with interstices between said wire, said channel extending to an end region of the connector, thereby enabling a lubricant or sealant to be introduced around said connector via said channel.

27. A pipe coupler comprising
a wall defining a receiving recess for receiving an end of a pipe length at each end of said coupler;
a connector-receiving groove located at each end of said coupler and formed to a depth in an internal surface of the wall of the receiving recess;
a channel communicating between the each connector-receiving groove and an external surface of the connection end;
said channel and groove being configured to receive a flexible elongate connector seatable within the groove via the channel, and said connector having a width greater than the depth of the groove so that when seated within the groove the connector extends into the receiving recess, and wherein the bore of the coupler is unimpeded by inwardly-extending projections.

28. A coupler according to claim 27, further comprising two O-ring receiving grooves circumferentially disposed on an internal surface of the wall of the receiving recess, and located between said connector-receiving grooves.
